(19) United States
(12) Patent Application Publication
(10) Pub. No.: US 2003/0025017 A1
(43) Pub. Date: Feb. 6, 2003

(54) Round baler with comminution device for waste materials

(75) Inventor: Olaf van der Lely, Zug (CH)

Correspondence Address: Penrose Lucas Albright, Esq., MASON, MASON & ALBRIGHT, P.O. Box 2246, Arlington, VA, 22202-0246, US

(73) Assignee: LELY ENTERPRISES, A.G.

(21) Appl. No.: 10/121,667

(22) Filed: Apr. 15, 2002

(30) Foreign Application Priority Data
Apr. 13, 2001 (EP) 01201366.0

(51) Int. Cl. B02B 5/02

(52) U.S. Cl. 241/101.76

(57) ABSTRACT

A round baler with a comminution device for waste materials which is carried on a truck bed or bed of tractor that picks up, comminutes and bales waste materials at various places and carries the waste material in the form of rolls therefrom without intermediate storage to a further place where the waste materials are stored, reprocessed or destroyed.

### FIELD OF INVENTION

The invention relates to a mobile round baler with comminution device for shredding, baling into rolls and removing waste materials such as paper or cardboard.

### BACKGROUND OF THE INVENTION

The above-described round baler is described in Offenlegungsschrift DE 197 12 793 A1 published Dec. 11, 1997 of Tamamori et al, in which comminution of paper or documents is initially performed using a cutting means arranged above the feed slot of a cylindrical baling chamber. The cut-up material from the cutting means is fed through the feed slot into the baling chamber and is there compacted into a round bale by drivable baling rollers arranged at the circumference, said round bale being easy in transport and economical with regard to storage space. The prior art round baler operates in stationary manner at its place of use and comprises wheels on which said round baler may be moved out of corners or recesses for maintenance and replacements of parts and is easily accessible for both purposes. After intermediate storage of these bales, they are then loaded onto a vehicle and conveyed to, for example, a recycling plant, where the bales are unloaded and introduced int this plant for processing. The baling components are provided are rollers, which have the disadvantage that a large quality of comminuted material falls downwardly out of the baling chamber onto the floor during the baling process.

When disposing of documents and files, in particular of relatively large quantities thereof, it is desirable to comminute the waste material at its place of origin and to compress it into bales to reduce its volume, these bales then being conveyed without intermediate storage and as directly as possible to the disposal site such as a recycling plant.

### SUMMARY OF THE INVENTION

The object of the invention is to provide a device with which waste materials may be comminuted and baled as cost-effectively as possible at various places of origin and carried away without intermediate storage.

The object of the invention is achieved in that the round baler may be carried and operated on a vehicle such as a trailer or a truck bed.

The basic concept of the invention is to use a round baler which previously operated only stationarily as a mobile round baler which is operated for example by a service provider. As soon as the round baler has completed its operations in one place, it may be driven on to the next place of use which is usually the next company where waste is produced which needs to be comminuted, baled and carried away for disposal. Thus, not only is it possible to dispense with investment in machinery, personnel and storage space at the point of origin of the waste, but it is also possible to comminute, bale and immediately remove confidential file material, for example, to the disposal site. A round baler is particularly suitable for use on a vehicle, because round balers exhibit relatively low intrinsic weight, are of compact structure, are economical, and in particular, due to the exclusively rotary nature of their baling components, do not subject the vehicle to any impacts, vibrations or relatively large loads during baling, while exhibiting relatively low energy requirements and a simple binding system.

The round baler may advantageously be operated on a mobile carrier. Here, recourse may be had to the commercially available roll compactors, types RV 641/642, made by the assignee, which may be mounted to a vehicle's loading area for example directly or by means of a simple auxiliary frame without technical alteration. Power is supplied from a conventional electric outlet via an extension cable. Charging of the compactor with paper or cardboard or both is effected manually. The costs involved in providing a device according to the invention are minimal. In addition the remaining available loading areas on the trailer or truck bed may also serve to carry away the compressed bales. The roll compactor is installed in the rear of the trailer or truck bed with its input openings facing to the rear. The operator may stand on the ground and easily feed in the waste material manually via a charging table and place the finished bales (approximate fifteen or twenty-five kilograms weight per bale) on the loading area. Also the roller baler may be mounted on a low-loader, such as a forklift vehicle.

To enable coupling to waste feed systems or delivery systems for the finished bales or both, the baler housing is preferably mounted horizontally on the vehicle so that of the input/operating side and output side are disposed opposite one another. In a further version of this embodiment, the round baler comprises a charging hopper for receiving the waste material.

Inasmuch as a round baler which is being used on a mobile basis calls at various points at which waste originates, it is important for the round baler to comprise a binder device with a means of storing one or more binding materials, in order to bind different types of baled materials in a segregated manner with corresponding binders.

A particular advantageous embodiment is achieved when the round baler comprises, as a baling component, one or more continuous conveyor belts extending over the entire width of the baling chamber. In this way, virtually no material falls through openings during the baling process.

According to a further feature of the invention, the round baler is driven by electrical energy, which is provided via a separate power unit or by a connection to a load electrical cable.

It is also possible, however, for the round baler to be driven by hydraulic or mechanical energy or by a combination thereof which is generated directly or indirectly by the vehicle engine. Further advantages and advantageous embodiments will be understood from the following description.

### BRIEF DESCRIPTION OF THE DRAWINGS

The invention is described in detail with reference to two exemplary embodiments what are illustrated in the drawings, in which:

FIG. 1 is a schematic side elevational view of a round baler mounted on a car trailer;

FIG. 2 is a plan view of FIG. 1; and

FIG. 3 shows a round baler arranged horizontally on a truck, with a conveyor device for charging the mechanism.

### DETAILED DESCRIPTION OF THE PREFERRED EMBODIMENTS

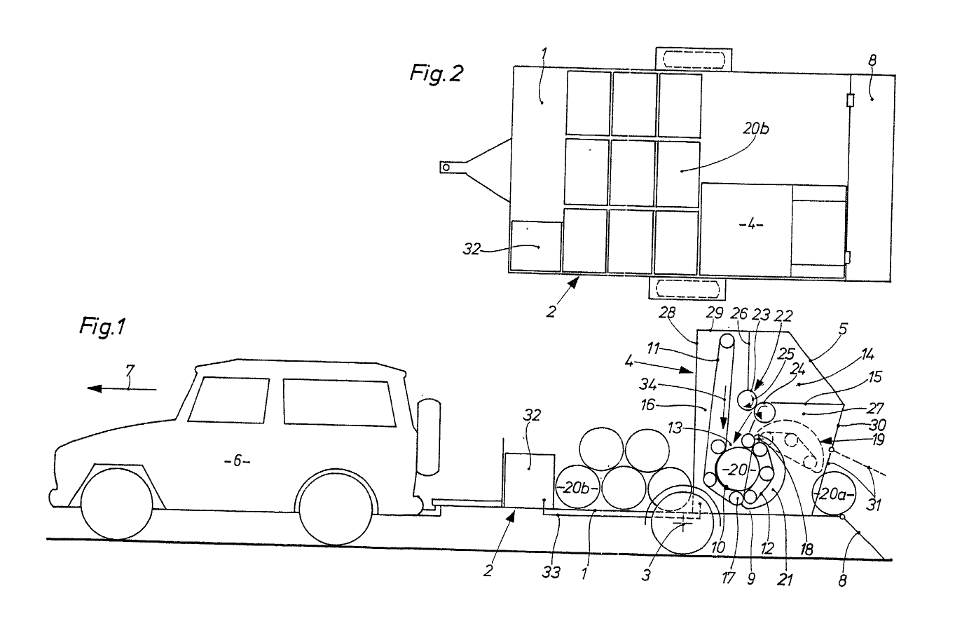

An operative round baler 4 is mounted on a loading area of trailer 2 supported by the trailer's axle 3, so that a charging opening 5 for waste material to be baled is directed to the rear. Trailer 2 is attached to a motor vehicle comprising an automobile 6, which may be station wagon or a SUV as seen in FIG. 1. The normal forward direction of travel of automobile 6 is indicated by arrow 7. The rear tailboard 8 of the trailer 2, which can be elevated to be closed is shown in the open position.

For details of the structure and mode of operation of a known round baler 4 for cardboard waste or the like, reference is made by way of example to German published patent Application DE 28 09 887 A1.

Such a round baler 4 consists substantially of a baler housing 9 with a baler charger 10 which is formed by two conveyor belt segments 11 and 12, wherein a feed slot 13 is defined at the top between conveyor belt segment 11 and conveyor belt segment 12 for feeding therein material to be baled from a charging chamber 14 via a charging table 15. The one conveyor belt segment 11 is mounted on deflection, drive rollers 17 in a fixed-frame baler housing part and extends upwards beyond feed slot 13. The other conveyor belt segment 12 is arranged in a baler housing part 21 which may be opened about an upper pivot axis 18 into a discharge position 19, shown by broken lines, for bales 20 formed between conveyor belt segments 11 and 12. A comminution device 22 in the form of two cutting rollers 23 and 24 is installed in charging chamber 14 above feed slot 13, which cutting rollers 23 and 24 are mounted laterally in baler housing 9 and may be driven in a revolving manner in the direction of arrows 25 to comminute the waste material loaded into charging chamber 14 to the desired size. Above cutting roller 23 and at right angles to charging table 15, a sheet metal wall 26 is provided which extends vertically adjacent conveyor belt segment 11, which sheet metal wall 26 forms a wall of charging chamber 14 and prevents unshredded waste material from being entrained by conveyor belt segment 11. An obliquely positioned baffle forms the transition between cutting roller 24 and feed slot 13.

If waste material is to be introduced in an unshredded state directly to baler chamber 10, upper cutting roller 23 and sheet metal wall 26 may easily be removed or optionally both cutting rollers 23 and 24 may be removed.

Baler housing 9 is defined in the axial direction of baler chamber 10 by two side walls 27 arranged side by side at a distance corresponding to the width of baler chamber. It is additionally defined externally by a forward wall 28, an upper cover 29 and a rear wall 30 to which there is hinged a bale removal flap 31 that extends approximately to the ground.

A wrapper device as known in the prior art, is arranged in the upper area between conveyor belt segment 11 and sheet metal wall 26 which is provided with a plurality of storage rolls for different binding materials, such as film, sisal yarn and plastic yarn. Depending on the waste material, the bale may thus be bound in segregated manner with a corresponding binding material.

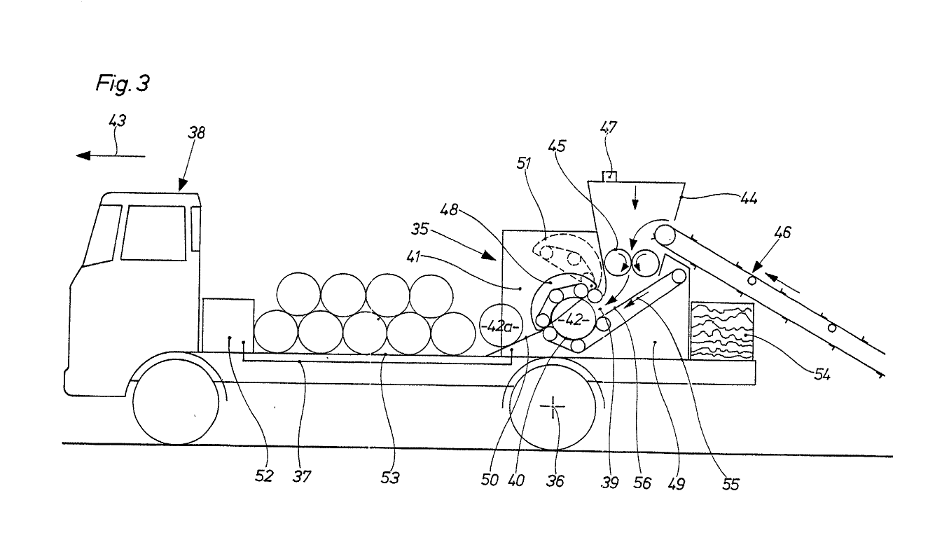

As clear from FIG. 2, round baler 4 is arranged on the left-hand rear half of trailer 2, when viewed in the direction of travel 7. However, it may also be mounted centrally or offset to the left. A power unit 32 is fitted in the front area of trailer 2 and is connected to round baler 4 vis supply lines 33. However, power may also be supplied from local electrical outlets by means of extension cables or derived hydraulically directly or indirectly from the motor vehicle engine.

The mode of operation of the device is as follows:

Round baler 4, mounted on trailer 2 is driven to the place of origin of the waste material. The waste material may be provided on pallets, for example. Once power unit 32 is activated and round baler 4 switched on, waste material is delivered by hand into charging chamber 14. Charging table 15 preferably comprises a conveyor belt which conveys the material towards cutting rollers 23 and 24, which comminute it and convey it through feed slot 13 into baling chamber 10. Conveyor belt segment 11 revolving in the direction of arrow 34 forces the cut up waste material into baling chamber 10. As material is fed therein, a round baling chamber 20 as shown in baler 10 in FIG. 1 is produced, which is wrapped automatically or manually with binding material at a given bale diameter determined as a function of torque, power, pressure or weight of bale 20. After opening of the baler housing part 21 into the discharge position shown in broken lines, round bale 20 is ejected, wherein bale flap 31 opens at the same time and bale 20 moves to the position indicated by bale 20a, as is discharged through the opening. The bales thus produced which weigh approximately fifteen to twenty-five kilograms are then stacked manually on loading area 1 of trailer 2. For a bale having a diameter of 0.4 meters and with a width of 0.6 meters, for example, three bales 20b (as the bales are designated at this location) may be stacked next to one another and two or three bales stacked on top of them, see FIG. 2. Once operations have been completed at one location, the combination motor vehicle/trailer/baler is driven to the next company which produces waste material. Instead of files, computer paper and documents, other wastes such as leaves for example may also be baled, these being tied up with compostable wrapping material.

The round baler 35 illustrated in FIG. 3 corresponds in function to round baler 4 described in detail with reference to FIG. 1, except that round baler 35 may be designed for larger bale dimensions, such as up to 1.2 meters bale diameter and the same width, and round baler 35 may be mechanically charged.

The operative round baler 34 is mounted horizontally on a loading area 37, which comprises the bed of a truck 38, over its rear axle 36. A feed slot 39 leading into a baling charger 40 is directed obliquely and rearwardly. An outlet opening 41 for finished round bales 42 is disposed in the normal forward direction of travel of truck 38 indicated by arrow 43. A charging hopper 44 is mounted above feed slot 39. A comminution device 45 is installed in charging hopper 44. Opening into charging hopper 44 from the rear is a conveyor belt 46, illustrated only in part, which is directed forwardly and obliquely upwardly, with one end resting on the ground and is surrounded, for example, by a conveyor duct, not shown, so that waste material located on conveyor belt 46 does not fall to the sides or blow away. Conveyor belt 46 may be mounted on the back of truck 38 and adjusted so as to be in a transport position. At its top, charging hopper 44 comprises a sensor system 47 which acts as a safety device, which may include a light barrier or an infrared sensor. Round baler 35 or the comminution device 45 or both can only be switched on if the sensor system 47 indicates that the charging hopper 44 is empty. A similar safety device may also be located in the area of the operable baler housing part 48, to prevent anyone from being put at risk during opening or closing of baler housing part 48. A baler housing part 49 mounted fixedly on loading area 37 comprises an inclined plane as a chute device for receiving round bales 42a. A power unit 52 is arranged in the front area of the bed of truck 38 and is connected to the round baler 35 via supply lines 53.

Round baler 35 operates as follows: waste material is supported on a pallet 54 either on the ground or on the loading area 37 or is transported thereto by a conveyor. The waste material is loaded onto conveyor belt 46 and conveyed into charging hopper 44. Conveyor belt 46 may be switched on and off for example manually or by an upper and lower light barrier in charging hopper 44. Comminution device 45 comminutes the waste material, which then drops onto a conveyor belt segment 56, revolving in the direction of arrow 55 and is fed into baling chamber 40 where it is compressed into a round bale 42. Once bale 42 has been bound with binding material, baler housing 48 is opened into its discharge position 51, as shown by broken lines, and round bale 42 travels along chute device 50 onto loaded area 37. In order also to be able to bale cardboard or other materials in an unshredded state, a bypass opening may be provided for this purpose on round baler 35.

Inasmuch as a round baler exhibits a low intrinsic weight relative to the total weight of a vehicle, a large part of the loading area may be used for bale transport. The bales are unloaded using loaders, such that the entire procedure extensively dispenses with a need for manual labor.

Although I have disclosed the preferred embodiments of my inventions it is to be understood that it is capable of other adaptations and modifications within the scope of the following claims.

Having thus disclosed my invention, what I claim as new and to be secured by Letters Patent of the United States is:

1. A round baler with comminution device for comminuting waste materials, which is mounted on the rear of a mobile bed wherein an opening for receiving said material is disposed to receive said waste material from a stationary platform which is—temporarily disposed adjacent said mobile bed.

2. A round baler according to claim 1 wherein said mobile bed comprises the supporting bed of a trailer

3. A round baler according to claim 1 wherein said mobile bed comprises a truck bed.

4. A round baler according to claim 1 wherein said mobile bed comprises the supporting means of a low-loader.

5. A round baler according to claim 1 which comprises a baler housing mounted vertically on said mobile bed.

6. A round baler according to claim 1, which comprises a baler housing mounted horizontally on said mobile bed.

7. A round baler according to claim 1 comprising charging means for conveying said material from said stationary platform.

8. A round baler according to claim 7, wherein said charging means comprises a charging hopper for receiving said waste material.

9. A round baler according to claim 1, wherein said comminution device is detachable and is arranged above a feed slot in a housing for forming said bales whereby said bales may be selectively formed with or without being comminuted by said comminution device.

10. A round baler according to claim 1 which comprises a document shredder.

11. A round baler according to claim 1 which comprises a safety device for said comminution device that prevents said comminution device from operating when any part of a human is likely to be injured by said comminution device.

12. A round baler according to claim 1 which comprises a housing part for ejection of a finished bale therefrom and a safety device that prevents said housing part from ejecting a finished bale when it is likely that said ejection will cause injury to any human.

13. A round baler according to claim 1 which comprises a means for supplying waste materials thereto which is connected upstream of a charging hopper for said waste material.

14. A round baler according to claim 1 which comprises means mounted on said mobile bed for delivery of compressed bales from the round baler onto a loading area of said mobile bed.

15. A round baler according to claim 1 which comprises a binder device with means for storing at least one binding material.

16. A round baler according to claim 1 which comprises at least one continuous conveyor belt which extends over the entire width of a baler chamber of the round baler.

17. A round baler according to claim 1 which comprises a means for returning small-sized parts of said waste material located beneath a baling chamber for said waste material to a charging means from said baling chamber.

18. A round baler according to claim 1 comprises an energy source for operating the round baler.

19. A round baler according to claim 18 wherein said energy source comprises an electrical energy supply means.

20. A round baler according to claim 18 wherein said energy source comprises a hydraulic energy supply which is generated by a vehicle engine for moving said mobile bed.

21. A round baler according to claim 19 wherein said electrical energy supply consists of a generator or a battery or both that are carried by a transporter that consists of said mobile bed or a vehicle to which said mobile bed is attached.

22. A round baler according to claim 1 which comprises a vehicle, a power unit and a loading area which receives and transports finished compressed bales made by the round baler.
